(19) United States
(12) Patent Application Publication
(10) Pub. No.: US 2005/0055403 A1
(43) Pub. Date: Mar. 10, 2005

(54) Asynchronous access to synchronous voice services

(76) Inventor: Paul St. John Brittan, Somerset (GB)

Correspondence Address: Richard P Berg;Hewlett-Packard Company, Intellectual Property Administration, P O Box 272400, Fort Collins, CO, 80527-2400, US

(21) Appl. No.: 10/493,330

(22) PCT Filed: Oct. 25, 2002
(86) PCT No.: PCT/GB02/04858

(30) Foreign Application Priority Data
Oct. 27, 2001 (GB) 0125892.0

(51) Int. Cl. G06F 15/16

(52) U.S. Cl. 709/206; 709/217

(57) ABSTRACT

The claims have been amended to clarify their scope having regard to the terms used and the operation of the described embodiments. More particularly, in claim 1:
The system by which user input is provided was originally referred to as an “asynchronous” system which is potentially misleading as the description makes it clear that the input can be collected by an audio server 33 (which would interact in a synchronous manner with respect to the user). Claim 1 is now clarified to indicate that it is the general interaction between the user and the synchronous transaction system that is asynchronous in nature rather than the operation of the user-input system. (though the latter could be asynchronous in operation). The qualification of the transaction system as a “voice” transaction system is potentially misleading because it is clear from the description that the interaction with the synchronous transaction system may occur at, for example, the VoiceXML script level without any voice signals being produced. Accordingly the qualification “voice” has been replaced by “human dialogue based”; whilst the term “human” is not explicitly present in the specification, it is implicit that the VoiceXML scripts mentioned in the description are or human dialogue. The asynchronous nature of the user interaction with the transaction system is now expressed in terms of the proxy seeking to respond to a request using input already provided by the user—that is, user input provided unprompted by the request. Of course, it may not be possible to respond to the transaction system on this basis and, in the described embodiment, the proxy may then fetch the required information from the user (or connect the user to the transaction system or simply notify the user without seeking a response). The independent method claim 16 has been amended along lines similar to claim 1 as has independent claim 31 (this latter claim is now directed to “an arrangement” since directing the claim to “a system” was confusing in view of two constituent elements also being systems). The amendments effected to the dependent claims are primarily to make these claims consistent with the amended independent claims though other clarifying amendments have also been made.

The present invention relates to a user proxy and session manager that enables asynchronous access to synchronous voice services, an information system including such a user proxy and session manager and a method of providing asynchronous access to synchronous voice services.

A synchronous service is, in general terms, a service where the parties to a “transaction” communicate in real time. Thus human to human conversations are an example of a synchronous transaction.

An asynchronous service is, in general terms, a service where the parties to a transaction do not communicate in real time. Thus traditional forms of communication such as letter writing, and more contemporary forms such as the “short message service” (SMS) represent forms of asynchronous communication. Thus, in an asynchronous environment a first party may have initiated a transaction with a second party, and the second party may be unaware that the transaction has been commenced. In a synchronous environment, the second party would be aware because it would have been contacted as part of a precursor or set up phase of the transaction.

“Voice services” are known automated systems that provide information or assistance to a user in response to spoken commands, information or queries provided by the user. In effect, the voice services allow the user to participate in a dialogue with the information system. The form of a dialogue and the style of interaction between the user and the voice service can take many forms. But in general the style of the dialogues can be broadly divided into two:

1) Directed dialogue, where the interaction between the user and the system is divided into sub-dialogues and the flow from one sub-dialogue to the next is dictated by directed questions.

2) Mixed initiative dialogue, where the interaction between the user and the system is more natural, allowing both the user and the system to introduce questions or volunteer information at any stage during an interaction.

A common use of directed dialogue voice systems is in the automated customer services industry where they are used to direct a customer to a specific customer service agent dependant on the nature of the customer's need. One such example is telephone banking services where the user is presented with a list of available options to select from, for example current account transactions or loan enquiries, each option directing the user to a further set of appropriate options until the user's need has been established to an appropriate degree.

Such voice services that employ a directed style of dialogue lend themselves to using a voice browser and a number of voice pages, each page being described in a mark-up language, such as VoiceXML. This scheme is closely analogous to the use of a web browser to access individual web pages. However, in the instance of voice browsers a speech recognition unit, and possibly a natural language understanding device, is required to convert the spoken responses input by the user into the appropriate representation prior to transmitting the responses to the relevant voice page. Additionally a text to speech unit for performing the reverse action may also be provided such that questions or information can be put to the user.

The advantage to the user of directed dialogue systems is that the style of dialogue is typically short and concise. Additionally, from the point of view of the service provider, the voice mark-up language allows the voice pages to be created without knowledge of the underlying hardware platform, software components, or speech technologies.

Conversely, the major draw back with directed dialogue systems is the constraints that they place on the user. For example, the use of vocabulary and grammar is restricted to only valid answers to questions within the sub-dialogue, the rigid sequential structure of the directed dialogue does not allow the user to skip ahead within the dialogue or to ask random questions.

However, directed dialogue systems are becoming increasingly popular as a way of implementing voice operated services.

Mixed initiative dialogues that allow both the user and system to introduce questions at any stage during an interaction tend to require large amounts of training, by which is meant the system must be trained to recognise voice and speech patterns and grammars, that will be encountered in use. For wider deployment such systems have to be user independent, and therefore tend to be limited to very specific applications. Examples of mixed initiative dialogue systems include travel enquiry and booking systems, weather report information systems and restaurant location and booking services.

An alternative to the voice services is provided by a number of different text, and indeed predominantly web based and Internet enabled services that allow a user to provide a enquiry or issue instructions using one or more different methods and subsequently providing a response to the user. For example, a user may send an enquiry to such a service using e-mail or SMS (text messaging), the enquiry being presented in a completely natural language format. The enquiries are then processed by the web based information-services, the available information retrieved and a response sent back to the user. Such access methods are asynchronous (i.e. not synchronous), as they do not require the user to be continuously connected to the service to perform an information request of transaction.

According to a first aspect of the present invention there is provided a proxy for providing access between a synchronous voice transaction system and an asynchronous system, the proxy being arranged to present a user input received from said asynchronous system to said synchronous voice transaction system.

Such a user proxy, or interface, will allow the information held on, for example, directed dialogue voice services to be retrieved by a user presenting their enquiry in an asynchronous manner, for example via e-mail or SMS text messaging.

Preferably the proxy is further arranged to report messages concerning the transaction received from said synchronous voice transaction system to said asynchronous system.

Preferably, the proxy provides data values to the synchronous voice transaction system in response to data requests from the synchronous voice transaction system, the data values being derived from the input received from the user.

The proxy maybe tailored or matched to the type of transaction system that the user is accessing.

Thus, for example, if a user messages a synchronous transaction system for a bank then the proxy is already provided with a knowledge that the user's message will be predominantly financially orientated and this information is of use when fitting the users instructions or request to the XML pages presented by the voice transaction system. Such a system will typically be limited to balance enquiries, cash transfers or bill payments and the proxy can utilise this knowledge.

Similarly, if a user sends a message (text or voice) to a transaction system for a pizza delivery service, then the proxy can use the contextual knowledge that the message is about pizza, and most probably an instruction to deliver a specific pizza to a specific address, to guide it in its interaction with the voice service.

A user's message may be an enquiry or an instruction, or indeed a conditional instruction dependent on the result of an enquiry or other test. For convenience these possibilities can be regarded as a user “transaction message”.

Preferably, the proxy is arranged to perform a matching operation between the data request received from said synchronous voice transaction system and the derived data values.

Preferably, if the matching operation fails the proxy is arranged to connect a user to the synchronous voice transaction system. Additionally, the proxy causes the synchronous voice enquiry system to repeat the data request at which the matching operation failed.

Alternatively, if the matching operation fails the proxy may be arranged to send a notification to the user. The notification may comprise a summary of the user transaction message and the results or requests provided from the synchronous voice transaction system prior to the failure of the matching operation.

Preferably the proxy includes a data mapping table comprising a plurality of data elements associated with the synchronous voice transaction system and corresponding data elements as derived from the user transaction message.

Additionally, if the matching operation fails, the proxy may be arranged to access the data mapping table and investigate any data element associated with said voice transaction system that corresponds to the umatched derived data element, to see if a match could occur.

Preferably, the proxy includes a response generator arranged to construct a response to said transaction message in response to receiving a message from the synchronous voice transaction system. Additionally, the response generator may include a response method selector arranged to select the method of providing the response. The response method selector may select the method in response to a received user preference, the user preference being retrieved from a stored user profile, or alternatively the method may be selected so as to match the method used by the user to supply the user input.

The method of response may comprise one or more of e-mail, SMS text messaging or text via a web page or speech, either directly or left as a voice message. Thus two communication media may be used together to contact the user.

According to a second aspect of the present invention there is provided an transaction system comprising an asynchronous transaction system, a synchronous voice transaction system, and a proxy, the proxy being arranged to interface the asynchronous transaction system to said synchronous voice transaction system.

Preferably the asynchronous transaction system further comprises a natural language converter arranged to parse the user's transaction message to generate a semantic frame representation of the transaction message.

Preferably, the synchronous voice enquiry system comprises a plurality of voice mark-up language pages, a web server and a voice browser.

Preferably, the asynchronous transaction system is arranged to receive speech, e-mail, SMS text messages or text via a web page as input.

According to a third aspect of the present invention, there is a provided a method of providing access between a synchronous voice transaction system and an asynchronous system, the method comprising providing an automated proxy arranged to accept a user input from said asynchronous system and to interface with the synchronous voice enquiry system.

A detailed description of an embodiment of the present invention, given by way of example, will now be described with reference to the accompanying drawings, in which:

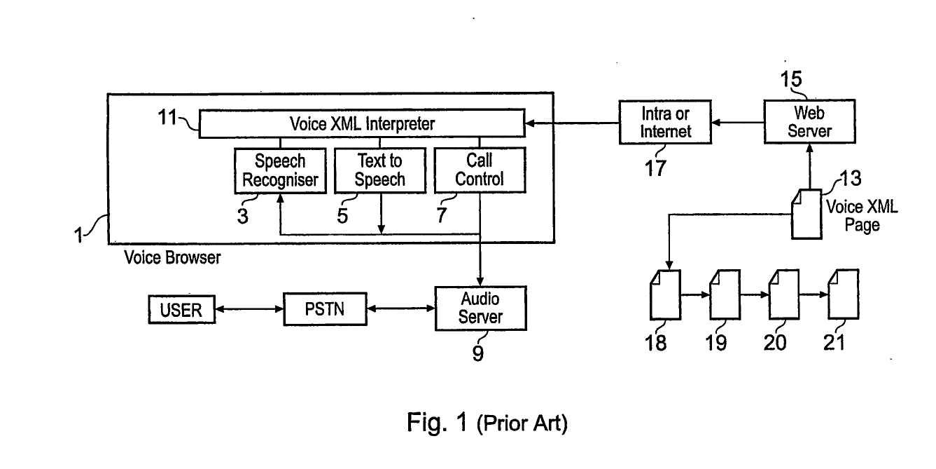

FIG. 1 is a functional block diagram of a known voice browser and associated voice mark-up pages enquiry system;

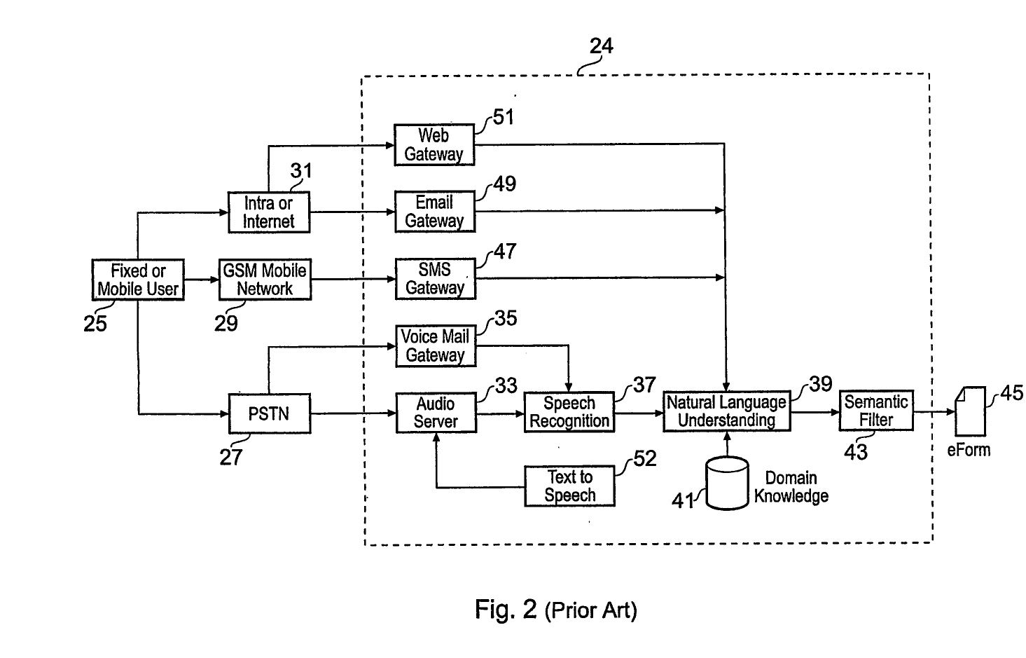

FIG. 2 is a functional block diagram of a known multiple access natural language enquiry system; and

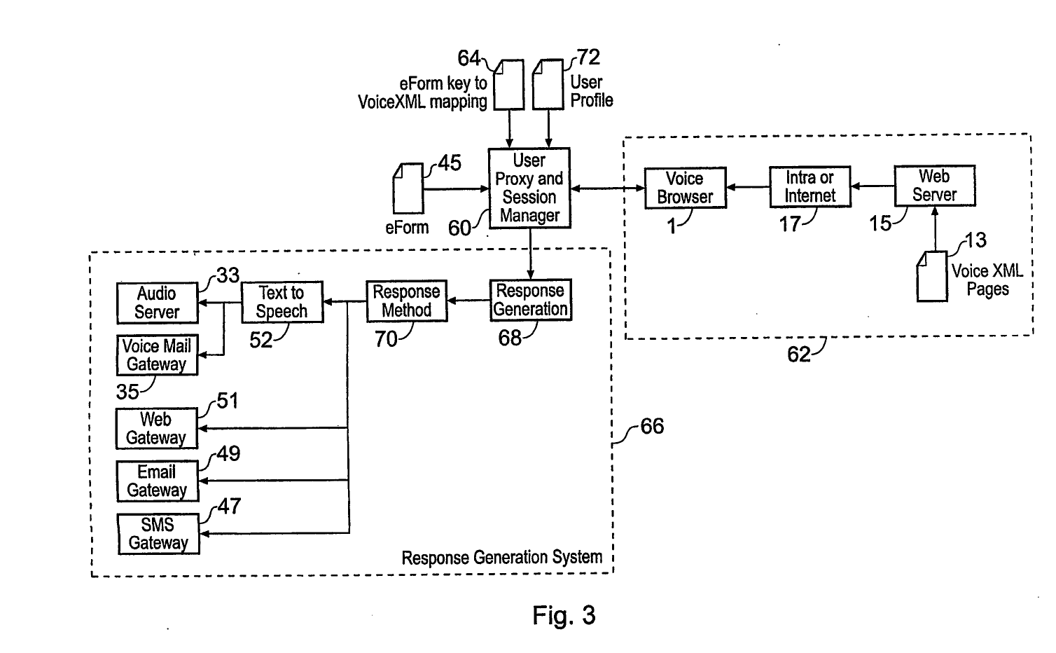

FIG. 3 is a functional block diagram showing a user proxy session manager and response generation apparatus in accordance with an embodiment of the present invention.

Although the voice browser transaction system shown in FIG. 1 and the multi access natural language transaction system shown in FIG. 2 are known prior art it is considered beneficial to describe their operation so as to enable the operation of the user proxy session manager of the present invention to be better understood in the context of these systems.

The voice browser system shown in FIG. 1 comprises a voice browser 1 that includes a speech recognition unit 3, a speech synthesiser or text-to-speech unit 5 arranged to output as an audio speech signal text that has been input to the speech synthesiser, a call control unit 7 that is arranged to connect the user to appropriate telephone line connections and extensions, an audio server 9 and a voice mark-up language (XML) interpreter 11. Most commonly the voice browser is accessed through a telephone connected to a public switched telephone network (PSTN) that connects to the audio server 9. However, a voice channel may equally be established across other communication mediums directly into the audio server 9, for example via the Internet using voice-over-IP.

On receiving a connection from the audio server 9, the voice browser 1 accesses a voice XML page 13 posted on a local or remote web server 15 via the Internet or an Intranet 17. The voice XML page 13 is input into the voice XML interpreter 11 within the voice browser 1. The voice XML interpreter 11 interprets the sequenced instructions held on the voice XML page 13 in order to control the speech recognition unit 3, text-to-speech unit 5, and the call control unit 7. Where a general purpose voice browser is provided to interface with a plurality of XML pages, the browser can use a knowledge of the telephone number dialled (even if the call has been redirected to the browser) to derive which web page should be accessed.

Typically the first voice XML page retrieved in response to a user connecting to the voice browser 1 contains a set of sequenced instructions to greet the user, list the spoken commands available, and await a spoken reply from the user. The greeting and list of spoken commands available are input to the text-to-speech unit 5 from the voice interpreter 11 and the text-to-speech unit 5 outputs the spoken audio greeting and list of commands to the user via the audio server 9. The voice XML Interpreter 11 ensures that the speech recognition unit in the voice browser 1 waits for a spoken reply from the user, or informs the text to speech unit to repeat the list of options after a suitable pause.

Upon receiving a spoken reply from the user, the reply is detected and interpreted by the speech recognition unit 3, the voice browser 1 analyses the response and requests the next appropriate voice XML page to be loaded into the voice XML interpreter 11 and the process is repeated. A number of voice XML pages 18-21 may require to be loaded to the voice XML interpreter 11 and the information contained therein output to the user via the text-to-speech unit S and audio server 9 before the dialogue is complete. The flow of the dialogue between the user and the voice browser is controlled by logic and variables embedded within the voice XML pages. The dialogue is terminated either on instruction at the end of the voice XML page chain, for example by connecting the user to a human operator or following the output of the last piece of available information, or when the user hangs up.

FIG. 2 illustrates an asynchronous multi access natural language transaction system 24 that is arranged to take an enquiry or instruction presented in a natural language format over one of a number of available access methods and produce from the natural language enquiry or instruction, an electronic form that identifies the key elements of information required to fulfil the transaction.

The user 25 has three basic methods of interacting with the transaction system, using voice access over the public switched telephone network (PSTN) 27, using a GSM mobile network 29 or via an Intranet or Internet 31. Enquiries or instructions received from the PSTN 27 maybe connected directly to an audio server 33 analogous to the audio server used in the voice browser system shown in FIG. 1, or maybe connected to a voice mail gateway 35 where the transaction message maybe left for retrieval at a later date. In either case the spoken transaction message is input to a speech recognition unit 37 that accepts the audio input and generates a sequence of possible translations of the spoken message, each having an associated confidence index. Each of the possible translations are then passed to the natural language understanding unit 39 that is arranged to apply previously stored domain knowledge containing valid vocabularies and grammars associated with the particular transaction service being utilised by the transaction system. By applying the domain knowledge 41 to each of the candidate translations provided from the speech recognition unit 37, the natural language understanding unit 39 is arranged to select the most likely translation corresponding to the spoken transaction message. The selected translation is then parsed to generate a semantic frame representation of the user's transaction message. This representation is then filtered by a semantic filter 43 to produce an electronic form 45 that comprises a series of identified keys (or variables) and their associated values. As an example, suppose that the user's transaction message was an enquiry concerning aircraft flight times to a particular destination. The keys contained in the electronic form 45 may include the chosen departure airport, the required designation airport, the date of travel and so on. The values associated with the keys, obtained from the domain knowledge 41, would be the actual selected airports and date of travel etc. This is represented by the table given below.

| Key | Value |
|---|---|
| Departure Airport | Heathrow |
| Destination Airport | Frankfurt |
| Preferred Date of Travel | Next Monday |

The natural language understanding unit 39 is also arranged to take its input directly as text from either a SMS text message gateway 47 connected to a GSM mobile network 29, an e-mail gateway 49 or web gateway 51. A text-to-speech unit 52 is also provided that provides an input to the audio server 33 such that a user accessing the system via the PSTN 27 maybe greeted by a greeting and asked to summarise their enquiry.

As previously discussed, it would be highly advantageous to provide a system that allowed the directed dialogue voice services enquiry system shown in FIG. 1 to be accessed by natural language enquiries input via a natural language enquiry system of FIG. 2. Such a system constituting to an embodiment of the present invention is shown in FIG. 3.

A user proxy and session manager 60 is provided and is arranged to receive as an input the eForm 45 containing the series of keys and their associated values representing an enquiry generated using the natural language enquiry system shown in FIG. 2. The user proxy and session manager 60 is also connected, or can connect itself, to a directed dialogue voice service system 62 such as that shown and described in FIG. 1. The proxy 60 can connect directly to the voice XML interpreter 11, thereby by-passing the speech recogniser 3, the text-to-speech converter 5 and the call control 7. Having received the eForm enquiry 45, the user proxy and session manager directly instructs the voice browser 1 to load and to start executing the appropriate voice XML page associated to the service that the user wishes to query. At points during the execution of the voice XML script where spoken user input is ordinarily required, the voice browser contacts the user proxy and session manager 60 with the request for the appropriate response. The user proxy and session manager compares the valid options provided from the voice browser 1 with the key value pairs in the eForm 45. If a match is found, the value is returned to the voice browser 1 and execution of the voice XML script continues in the same manner as if the user had spoken the response. It would therefore appreciated that the voice browser 1 does not necessarily have to include a speech recogniser or text-to-speech unit as in the voice browser illustrated in FIG. 1, although it is anticipated that such units will be included as the directed dialogue voice system 62 will also be available for direct access enquiries from other users and may be called upon if the proxy fails.

If a match with the key value pairs in the eForm 45 is not immediately found, a mapping process is performed that applies a previously stored mapping 64 to the eForm 45 that maps the variable names with in the voice XML query to those used in the eForm. The matching process is then repeated. Assuming that a successful match is found, the voice browser execution continues until the voice service has established all the information it needs to perform the transaction. At this point the user proxy and session manager passes the voice XML description of the result of the transaction or confirmation thereof to a response generation system 66, and more precisely to a response generation unit 68 within the generation system 66. The response generation unit 68 translates the provided response into a natural language response suitable to be presented to the user. This process is effectively the reverse of that conducted by the natural language understanding unit 39 provided in the natural language enquiry system shown in FIG. 2. The natural language response is then passed to a response method selector unit 70 that selects the users preferred output medium. The preferred output medium is determined from a user profile 72 that may have a previously registered user preferences stored within it, or alternatively stores a users preferred communication medium when the users transaction message is received by the user proxy and session manager. The preferred output medium maybe stipulated by the user in the transaction message presented to the system, or it may simply be assumed to be the same medium as was used to present the transaction message.

The response is then passed by the response method selector to either a web gateway 51, e-mail gateway 49 or a SMS gateway 47 in the case that the preferred output medium is text, or passed to a text-to-speech unit 52 and output to either an audio server or voice mail gateway 35. The audio server 33, voice mail gateway 35, web gateway 51, e-mail gateway 49, and SMS gateway 47 maybe the same gateways that are provided within the natural language enquiry system shown in FIG. 2 and that are used to receive the input enquiry.

If a match between the expected response from the voice browser 1 and the information held in the eForm 45 cannot be found then the user proxy and session manager may deal with this by a variety of ways. The user proxy and session manager may establish a direct voice connection between the user and the voice browser, rerunning the last sub-dialogue within the voice XML dialogue. The user is then free to continue to interact with the voice service 62 directly through the voice browser 1. This course of action is obviously only available if the user can be connected to the natural language enquiry system via a speech input gateway. Alternatively, the user proxy and session manager may summarise the sub-dialogue query that could not be satisfied by the information held in the eForm 45 and output this summary via the response generation system 66 to the user using the users preferred output medium as a prompt to the user to supply the missing information.

In the latter case the user proxy and session manager stores the current position within the voice service dialogue whilst it awaits a reply from the user. Hence the reply need not be immediate as the user proxy and session manager is capable of using the stored position to instruct the voice browser to access the appropriate sub-dialogue at any time. Once a reply has been received from the user, irrespective of the input means used, the eForm 45 is updated and the voice browser continues to execute the voice XML script from the stored position. Thus the transaction can be continued with.

It is of course possible that the user may wish to access the service via the Internet. In this case, once the user has entered the address of the URL, they are presented with an appropriate web page which asks the questions which will be posed by the voice browser. The web page can collect the appropriate information, optionally perform a consistency check of it, and then present the information and appropriate fields for passing to the voice browser.

While the preferred arrangement discussed here utilises a natural language enquiry system of the type discussed with reference to FIG. 2, it should be noted that this is not essential to the invention in its broadest aspects. Such a natural language enquiry system is particularly useful to employ when the query is received asynchronously, but other mechanisms can be employed either to provide sufficient structure to the asynchronous input, if required, or to interpret the input received asynchronously within the synchronous system.

It is thus possible to provide an automated interface between asynchronous communication channels and synchronous transaction services such as voice browsers.

1. A proxy for enabling a user to interface asynchronously with a synchronous, human dialogue based, transaction system, the proxy being arranged to seek to respond to a dialogue request from the transaction system by using user input previously provided by the user unprompted by said request and received by the proxy from a user-input system.

2. A proxy according to claim 1, wherein the proxy is so arranged that, upon receiving a said request requesting data concerning a particular subject identified by a key, it seeks to match this key with the key of any key-value pairs in user input received from the user-input system; the proxy being further arranged such that, upon a match being found, it returns the value of the matched key-value pair to the transaction system.

3. (canceled)

4. A proxy according to claim 1, wherein the proxy is so arranged that if the user input received from the user-input system is inadequate for responding to said request, the proxy connects the user to said transaction system.

5. A proxy according to claim 4, wherein the proxy is further arranged such that, upon the user being connected to the transaction system, it causes said transaction system to repeat said request.

6. A proxy according to claim 1, wherein the proxy is so arranged that if the user input received from the user-input system is inadequate for responding to said request, the proxy notifies the user.

7. A proxy according to claim 6, wherein said notification comprises a summary of results or request provided from said transaction system.

8. A proxy according to claim 2, wherein said proxy, in seeking to match a key received from the transaction system with the key of a user-input key-value pair, is arranged to use a data mapping table giving correspondences between keys used by the transaction system and keys used by the user-input system.

9. (canceled)

10. A proxy according to any preceding claim, wherein said proxy includes a response generator arranged to construct a response to said user upon receiving a concluding output from said transaction system.

11. A proxy according to claim 10, wherein said response generator includes a response method selector arranged to select the method of providing said reply.

12. A proxy according to claim 11, wherein said response method selector is arranged to select said method in response to a received user preference.

13. A proxy according to claim 12, wherein the proxy is arranged to retrieve said user preference from a stored user profile.

14. A proxy according to claim 11, wherein said response method selector is arranged to select said method so as to match the method used by the user-input system in obtaining the user input.

15. A proxy according to any one of claims 11 to 14, wherein said response method comprises at least one method selected from the list containing speech, e-mail, SMS text message and web pages.

16. A method for enabling a user to interface asynchronously with a synchronous, human dialogue based, transaction system, the method comprising providing an automated proxy that seeks to respond to a dialogue request from the transaction system by using user input previously provided by the user unprompted by said request and received by the proxy from a user-input system.

17. A method as claimed in claim 16, wherein said proxy, upon receiving a said request requesting data concerning a particular subject identified by a key, seeks to match this key with the key of any key-value pairs in user input received from the user-input system; the proxy, upon a match being found, returning the value of the matched key-value pair to the transaction system.

18. (canceled)

19. A method according to claim 16, wherein if the user input received from the user-input system is inadequate for responding to said request, said proxy connects a user to said transaction system.

20. A method according to claim 19, wherein said proxy, upon the user being connected to the transaction system, causes said transaction system to repeat said request.

21. A method according to claim 18, wherein if the user input received from the user-input system is inadequate for responding to said request, said proxy notifies the user.

22. A method according to claim 21, wherein sad notification comprises a summary of requests and results provided from said transaction system.

23. A method according to claim 16, wherein said proxy, in seeking to match a key received from the transaction system with the key of a user-input key-value pair, uses a data mapping table giving correspondences between keys used by the transaction system and keys used by the user-input system.

24. (anceled)

25. A method according to any one of claims 16 to 24, wherein said proxy includes a response generator that constructs a reply to said user in response to receiving a concluding output from said transaction system.

26. A method according to claim 25, wherein said response generator includes a response method selector that selects the method of providing said reply.

27. A method according to claim 26, wherein said response method selector selects said method in response to a received user preference.

28. A method according to claim 27, wherein said user preference is retrieved from a stored user profile.

29. A method according to claim 26, wherein said response method selector selects said method so as to match the method used by the user-input system in obtaining said user input.

30. A method according to any one of claims 26 to 29, wherein said method is selected from the list comprising speech, e-mail, SMS text message and web page communication.

31. An arrangement comprising:
a user-input system for obtaining user input from a user;
a synchronous, human dialogue based, transaction system;
a proxy for enabling a user to interface asynchronously, via said user-input system, with the synchronous transaction system;
the proxy being arranged to seek to respond to a dialogue request from the transaction system by using user input previously provided by the user unprompted by said request and received by the proxy from the user-input system.

32. An arrangement according to claim 31, wherein the user-input system comprises a system for synchronously or asynchronously obtaining user input in natural language form and for deriving from this input key-value pairs for passing to the proxy.

33. An arrangement according to claim 31 and 32, wherein said synchronous transaction system comprises a plurality of voice mark-up language pages, a web server and a voice browser.

34. (canceled)
